(19) United States
(12) Patent Application Publication
(10) Pub. No.: US 2022/0347039 A1
(43) Pub. Date: Nov. 3, 2022

(54) MOTORISED APPARATUS FOR ASSISTING WITH WALKING, AND METHOD FOR CONTROLLING SAID ASSISTING APPARATUS WITH AN ELECTRONIC HANDLE

(71) Applicant: GEMA, Ivry-Sur-Seine (FR)

(72) Inventors: Viviane PASQUI, Viroflay (FR); Pascal MARTINELLI, Sceaux (FR)

(21) Appl. No.: 17/761,008

(22) PCT Filed: Sep. 18, 2020
(86) PCT No.: PCT/FR2020/051630

§ 371 Date: Apr. 25, 2022

(30) Foreign Application Priority Data
Sep. 18, 2019 (FR) 1910306

(51) Int. Cl. A61H 3/00; A61H 3/02; A45B 9/02; A61G 7/10; G01L 5/166; G01L 5/22

(52) U.S. Cl. CPC A61H 3/00; A61H 3/02; A45B 9/02; A61G 7/1049; G01L 5/166; G01L 5/226; A61H 2201/1207; A61H 2201/5061; A61H 2201/0153; A61H 2201/5092; A45B 2009/002

(57) ABSTRACT

The invention relates to an electronic handle (1) or a walking assistance apparatus equipped with such a handle, said electronic handle being arranged so as to allow the measurement of at least one component of a force applied thereto, said handle (1) comprising a central part (10) and an outer jacket (20), said electronic handle (1) being characterized in that it comprises a first photoelectric cell (30) and a first shutter element (40), arranged so that a force applied to the electronic handle (1) is capable of causing a change in the amount of photons received by a first receiver (32), said change being proportional to a first component of the force applied to the electronic handle (1).

The invention relates to the field of electronic handles, and more particularly to electronic handles configured to measure one or more components of a force applied thereto and which can be used in particular in robotics for the control of motorized devices. The invention relates in particular to a walking assistance apparatus equipped with such an electronic handle, said apparatus being configured, for example, so that its movements can be controlled according to the one or more forces applied to the handle. The invention also relates to a method for controlling a walking assistance apparatus, said method implementing such an electronic handle.

### PRIOR ART

Electronic handles are used for many applications in everyday life and in industry. For example, they can be used to control robotic devices such as robotic arms or mobile motorized devices.

Several types of electronic handles have been developed that are capable of determining the forces applied to the handle according to one or more degrees of freedom of translational or rotational movement. To this end, electronic handles generally include force sensors such as position, torque, force, or pressure sensors. Effort sensors have been widely used because, on the one hand, they allow direct measurement of the users motion intention and, on the other hand, they offer a user-friendly and intuitive way to control the robot or mobile device.

The world's aging population is growing rapidly, and the percentage of older adults is expected to increase from 10% in 2000 to 24% by 2030 (Shishehgar et al. A systematic review of research into how robotic technology can help older people. Smart Health. Volumes 7-8, June 2018, Pages 1-18). The need for care of the elderly will therefore increase, even though it is already high, particularly in countries such as Japan, the United States, Canada, Australia and in Europe. Walking speed is a significant marker of the adverse consequences of aging, and it has been shown that the risk of mortality was increased by 90% in adults whose walking speed was significantly reduced within only two years, while reduced walking speed could also predict future hospitalization and disability (White D K et al. Trajectories of gait speed predict mortality in well-functioning older adults: the Health, Aging and Body Composition study. J Gerontol A Biol Sci Med Sci. 2013. April; 68(4):456-64).

Taking care of a person with walking and balance problems is based on three aspects: rehabilitation, adjustment of the living environment, and the use of technical aids. Waking assistance apparatus or technical aids for walking allow a person with walking and/or balance problems to regain some independence. These disorders have various origins and can affect all ages, but are common in the context of physiological aging.

Nevertheless, technical walking aids (for example a cane, walking frame, walker) are still rudimentary. Their misuse or even their non-use and the aggravation of the disorders lead to the use of a wheelchair. An alternative is the use of robotic technical walking aids, which by their motorization and by the interpretation of sensor data facilitate and secure the use.

When using motorized assistance, it is necessary to act on the motors to control the technical walking aid. One way to make a Human-Machine Interface is the button box. The activation of functions through a button box, however simple, is an additional task that is difficult to perform, especially in conjunction with walking, for frail elderly people.

However, walking aids systematically include handles on which users lean to maintain their balance. The handles are therefore naturally the elements of the robot in contact with its user. However, the information collected in the hand-handle contact can be used to control the robot, the electronic handles thus becoming Human-Machine Interfaces.

Based on this concept, walking assistance apparatus equipped with electronic handles having unidirectional (along the length of the handle) force sensors using FSR (“Force Sensing Resistors” in Anglo-Saxon terminology) technology have been proposed (A. C. Morris et al. A robotic walker that provides guidance, in: Proceedings of the 2003 IEEE Conference on Robotics and Automation, 2003, pages 25-30; F. Shi et al. Based on force sensing-controlled human-machine interaction system for walking assistant robot, in: Proceedings of the 8th World Congress on Intelligent Control and Automation, Jinan, China, 2010, pages 6528-6533).

Potentiometers have also been proposed to determine the intended direction of travel (A. J. Rentschler et al. Clinical evaluation of Guido robotic walker, Journal of Rehabilitation Research and Development 45(9) (2008) 1281-1294) as well as strain gauge-type effort sensors to instrument walker handles (A Frizera-Neto et al. Empowering and Assisting Natural Human Mobility: The Simbiosis Walker, Int J Adv Robotic Sy, 2011, Vol. 8, No. 3, Special Issue Assistive Robotics; W. Zhou et al. An intent-based control approach for an intelligent mobility aids, in: second International Asia Conference on Informatics in Control, Automation and Robotics, 2010, pages 54-58).

Nevertheless, the force or effort sensors used until now in these electronic handles are expensive devices.

Thus, there is a need for an electronic handle capable of detecting the application of a force greater than 15 newtons while not incorporating the costly and bulky sensors of the prior art.

### Technical Problem

The invention therefore aims to overcome the disadvantages of the prior art. In particular, the invention aims at providing an electronic handle capable of measuring at least one component of a force applied thereto and this from a simple, robust and inexpensive measuring component.

The invention further aims at providing a walking assistance apparatus incorporating such a handle, said walking assistance apparatus being intuitively controllable from the data generated by the electronic handle. Furthermore, the invention aims at providing a method for controlling such a walking assistance apparatus from the generated data.

### Brief Description of the Invention

To this end, the invention relates to an electronic handle arranged to allow the measurement of at least one component of a force applied thereto, said electronic handle comprising a central part and an outer jacket, said electronic handle being characterized in that it comprises:
a first photoelectric cell, said first photoelectric cell having a first diode capable of emitting a light beam and a first receiver arranged to receive said light beam, said first photoelectric cell being configured to generate a current proportional (for example of proportional intensity or voltage) to an amount of photons received by the first receiver, and
a first shutter element capable, depending on its position with respect to the first photoelectric cell, of changing the amount of photons received by the first receiver,
and in that, of the first photoelectric cell and the first shutter element, one is attached to the outer jacket and the other is attached to the central part so that a force applied to the electronic handle, capable of at least partially moving the outer jacket, is capable of causing a change in the amount of photons received by the first receiver, said change being proportional to a first component of the force that has been applied to the electronic handle.

Thus, such an electronic handle allows the control of a robot or more widely of a motorized mobile device without the user wearing sensors or operating buttons (or another interface). Such an arrangement makes it possible to detect a force, applied to the handle, greater than or equal to two kilograms. In a context of analysis of the interaction between a user and the handle, in particular in the context of a walking assistance device, this is largely sufficient.

In addition, such an arrangement makes it possible to determine a value of an applied force and does not merely detect a threshold being exceeded. Thus, it may be possible for a processor to process information differently depending on the level of force that has been applied to the electronic handle.

According to other optional features of the electronic handle, the latter may optionally include one or more of the following features, alone or in combination:
it comprises:
   at least one second photoelectric cell comprising a second diode capable of emitting a light beam, a second receiver being arranged to receive said light beam, and
   a second shutter element, the second shutter element being capable, depending on its position with respect to the second photoelectric cell, of changing the amount of photons received by the second receiver,
and the second photoelectric cell, preferably positioned substantially perpendicular to the first photoelectric cell, is arranged so that a force applied to the electronic handle, capable of at least partially moving the outer jacket, is capable of causing a change in the amount of photons received by the second receiver, said change being proportional to a second component of the force that has been applied to the electronic handle, said second component of the force preferably being perpendicular to the first component of the force.
Such an electronic handle, fitted with sensors measuring forces along the length of the handle and perpendicular to the length of the handle in a decorrelated manner and allowing calibration without manual intervention on the handle and its electronics. Thus constituted, the system, inexpensive, has two advantages compared to other systems: i) it allows to acquire independent measurements and ii) the measurements are self-calibrated, since the ‘zero’ is obtained when no force is applied on the system and the measured applied force can advantageously correspond to a percentage of the displacement of the shutter element compared to its maximum displacement.
of the second photoelectric cell and the second shutter element, one is attached to the outer jacket and the other, not attached to the outer jacket, is attached to the central part. Thus, the handle measures the movement of the outer jacket with respect to the central part. Alternatively, both the second photoelectric cell and the second shutter element can be attached to the central part or the outer jacket. In this case, the attachment means used are arranged so as to put a movement of one in relation to the other. Where this movement is a function of the movement of the outer jacket with respect to the central part.
the second photoelectric cell is attached to the second shutter element and the second shutter element is positioned in contact with the outer jacket and the central part. Preferably, the second shutter element comprises a movable protrusion capable, depending on its position with respect to the second photoelectric cell, of changing the amount of photons received by the second receiver. Such an arrangement may allow for easier manufacturing of the handle.
at least one shutter element is attached directly or indirectly to the outer jacket.

Attachment to the outer jacket is easy and can allow for increased sensitivity.
at least one photoelectric cell is attached directly or indirectly to one end of the outer jacket. In particular, the one or more photoelectric cells are attached to the ends of the outer jacket.
the outer jacket is arranged so that it can translate, under the effect of a force comprising a horizontal component, by at least one tenth of a millimeter with respect to a longitudinal axis of the central part. For this, the choice of material and its thickness is important. The displacement of at least one tenth of a millimeter, preferably at least one thousandth of a millimeter, provides sufficient sensitivity to the handle.
the outer jacket has a substantially tubular, preferably tubular, shape and a Young's modulus of less than 200 GPa. This allows a good sensitivity of the device.
the outer jacket is arranged so that it can translate, under the effect of a force comprising a vertical component, by at least one tenth of a millimeter with respect to an axis orthogonal to a longitudinal axis of the central part. This can be achieved by placing an elastic or spring-like element at one end of the outer jacket closest to the sit-to-stand lift (or furthest from the user). This allows a second force to be measured in a sensitive way.
the outer jacket is made of a material having a Young's modulus of less than 200 GPa and the central part is made of a material with a Young's modulus of at least 200 GPa. A difference in the Young's modulus of the materials used is one of the ways to achieve good sensitivity of the electronic handle.
the one or more photoelectric cells are attached to the ends of the outer jacket. This increases the sensitivity of the measurement.

According to another aspect, the invention relates to a walking assistance apparatus equipped with at least one, preferably at least two, electronic handles according to the invention, said walking assistance apparatus preferably being selected from: a cane, a crutch, a walker, a motorized walker, a walker with a lifting function, and a motorized chair.

In particular, the invention relates to a walking assistance apparatus comprising at least one motor, at least one electronic handle, the at least one electronic handle being arranged to allow the measurement of at least two components of a force applied thereto, said electronic handle being characterized in that it comprises:
a first photoelectric cell, said first photoelectric cell having a first diode capable of emitting a light beam and a first receiver arranged to receive said light beam, said first photoelectric cell being configured to generate a current proportional to an amount of photons received by the first receiver, and
a first shutter element capable, depending on its position with respect to the first photoelectric cell, of changing the amount of photons received by the first receiver,
the first photoelectric cell and the first shutter element being arranged so that the force applied to the electronic handle is capable of causing a change in the amount of photons received by the first receiver, said change being proportional to a first component of the force that has been applied to the electronic handle,
a second photoelectric cell comprising a second diode capable of emitting a light beam and a second receiver arranged to receive said light beam, said second photoelectric cell being configured to generate a current proportional to an amount of photons received by the second receiver,
a second shutter element capable, depending on its position with respect to the second photoelectric cell, of changing the amount of photons received by the second receiver,
the second photoelectric cell and the second shutter element being arranged so that the force applied to the electronic handle is capable of causing a change in the amount of photons received by the second receiver, said change being proportional to a second component of the force that has been applied to the electronic handle, said electronic handle being configured to control said motor depending on the values of the two calculated force components.

According to other optional features of the walking assistance apparatus, the latter may optionally include one or more of the following features, alone or in combination:
the walking assistance apparatus has two electronic handles. This makes it possible to better transcribe the users commands into commands for the one or more motors.
the two components, on which the changes in the amounts of photons received by the receivers depend, are components with respectively perpendicular directions. This facilitates the fusion of sensor data at the time of processing and thus facilitates the control of the one or more motors.
the electronic handle is configured so that the first component and the second component of the force applied to the electronic handle are not capable of causing a significant change in the amount of photons received by the second receiver and by the first receiver, respectively. This facilitates the fusion of sensor data at the time of processing and thus facilitates the control of the one or more motors.
the electronic handle comprises a central part and an outer jacket and the electronic handle is arranged so that a force, adapted to the control of the walking assistance apparatus, applied to the electronic handle is capable of at least partially moving the central part or the outer jacket, preferably capable of at least partially moving the central part. Such an arrangement makes it possible to easily follow the application of a force on the electronic handle.
the first photoelectric cell and/or the first shutter element and the second photoelectric cell and/or the second shutter element are attached to the central part. Such an arrangement makes it possible to easily follow the application of a force on the electronic handle.
the central part comprises at least one embedded beam comprising an embedded end and a free end, said free end having a degree of freedom along the direction of the second component of the applied force. Such an arrangement makes it possible to easily follow the application of a force on the electronic handle.
the free end does not have a degree of freedom in the direction of the first component of the applied force. Such an arrangement makes the measurements of the two components independent, facilitates the fusion of sensor data at the time of processing, and thus facilitates the control of the one or more motors.
the second photoelectric cell is attached to the central part, within a suitable cavity and the second shutter element is attached to the free end of the embedded beam. Such an arrangement makes it possible to easily follow the application of a force on the electronic handle.
the outer jacket is coupled to the central part via at least one force transmitting element arranged to pass through a housing provided in the free end of the embedded beam. Such an arrangement makes the measurements of the two components independent, facilitates the fusion of sensor data at the time of processing, and thus facilitates the control of the one or more motors.
the force transmitting element is arranged not to be in direct or indirect contact with the central part in the absence of a force applied to the electronic handle, preferably the force transmitting element has a clearance fit at the housing provided in the free end. This improves the accuracy of measurements.
the central part comprises a deformation bridge comprising a through opening which opens onto a recess, said through opening being arranged to experience elastic deformation as a function of the first component of the applied force. Such an arrangement makes it possible to easily follow the application of a force on the electronic handle.
the first photoelectric cell and the first shutter element are respectively positioned on either side of the through opening of the deformation bridge. Thus, the elastic deformation experienced along the axis of the second component of the applied force causes a change of the amount of photons received by the second receiver which is a function of the first component of the applied force.
the central part has at least two central openings positioned between the at least one embedded beam and the deformation bridge.
the central part is made of a material having a Young's modulus greater than or equal to 60 GPa.
The walking assistance apparatus is selected from: a motorized cane, a motorized crutch, a motorized walker, a walker with a lifting function, and a motorized chair.

According to another aspect, the invention relates to a method for controlling a walking assistance apparatus comprising at least one motor and one electronic handle, said method comprising a measurement of a value of at least one component of a force applied to said electronic handle, said electronic handle comprising a central part, an outer jacket, a first photoelectric cell having a first diode and a first receiver, and a first shutter element, said measurement of a value of at least one component of a force applied to said electronic handle comprising the following steps:
Emitting a light beam by the first diode,
Generating a first current proportional (for example of proportional intensity or voltage) to an amount of photons received by the first receiver,
Measuring an intensity value of the first current,
Moving the first shutter element under the effect of a force applied to said electronic handle,
Generating a second current proportional to an amount of photons received by the first receiver,
Measuring an intensity value of the second current, and
Calculating a value of at least one component of an applied force from the current values of the first current and the second current,

said method further comprising a step of controlling the at least one motor based on the value of at least one component of a calculated applied force.

Thus, such a method makes it possible to determine the value of a force component applied to the handle from an electronic handle comprising a photoelectric cell and a shutter element. Such a method is also simple, and the results obtained can be used to control at least one motor of the walking assistance apparatus.

In particular, the invention may also relate to a method for controlling a walking assistance apparatus according to the invention, said method comprising a measurement of values of at least two components of a force applied to said electronic handle, said electronic handle comprising a first photoelectric cell having a first diode and a first receiver, and a first shutter element, and a second photoelectric cell having a second diode and a second receiver, and a second shutter element, said measurement of a value of at least two components of a force applied to said electronic handle comprising the following steps:
Emitting a light beam by the first diode and second diode,
Generating first currents proportional respectively to an amount of photons received by the first receiver and second receiver, respectively,
Measuring the values of the first currents (for example intensity or voltage values of the currents),
Moving the first shutter member and/or the second shutter member under the effect of a force applied to said electronic handle,
Generating second currents proportional to an amount of photons received by the first receiver and second receiver, respectively,
Measuring the values of the second currents, and
Calculating the values of at least two components of the force applied to the electronic handle from the values of the first currents and the second currents;

said method further comprising a step of controlling the at least one motor according to the calculated values of the at least two components.

Other implementations of this aspect include computer systems, apparatus and corresponding computer programs recorded on one or more computer storage devices, each configured to perform the actions of a method according to the invention. In particular, a system of one or more computers may be configured to perform particular operations or actions, especially a method according to the invention, by installing software, firmware, hardware or a combination of software, firmware or hardware installed on the system. In addition, one or more computer programs may be configured to perform particular operations or actions by means of instructions which, when executed by data processing equipment, cause the equipment to perform the actions.

Other advantages and features of the invention will appear upon reading the following description given by way of illustrative and non-limiting example, with reference to the appended figures:

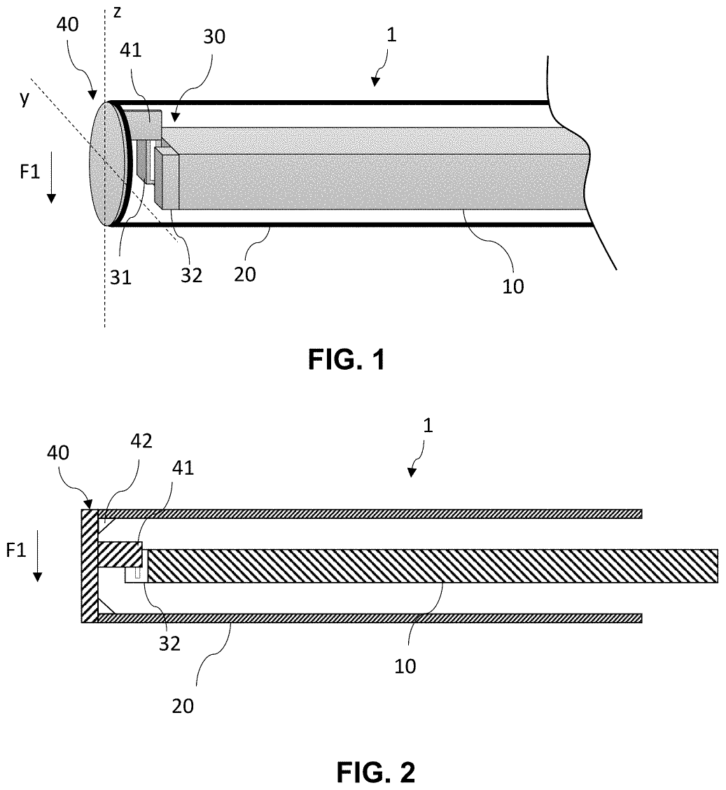

FIG. 1 is an illustration of a perspective view of an electronic handle according to one embodiment of the invention. Where the outer jacket is shown in transparency to allow visualization of the inside of the handle.

FIG. 2 is an illustration of a side view of a longitudinal section along a z-axis of a handle according to one embodiment of the invention.

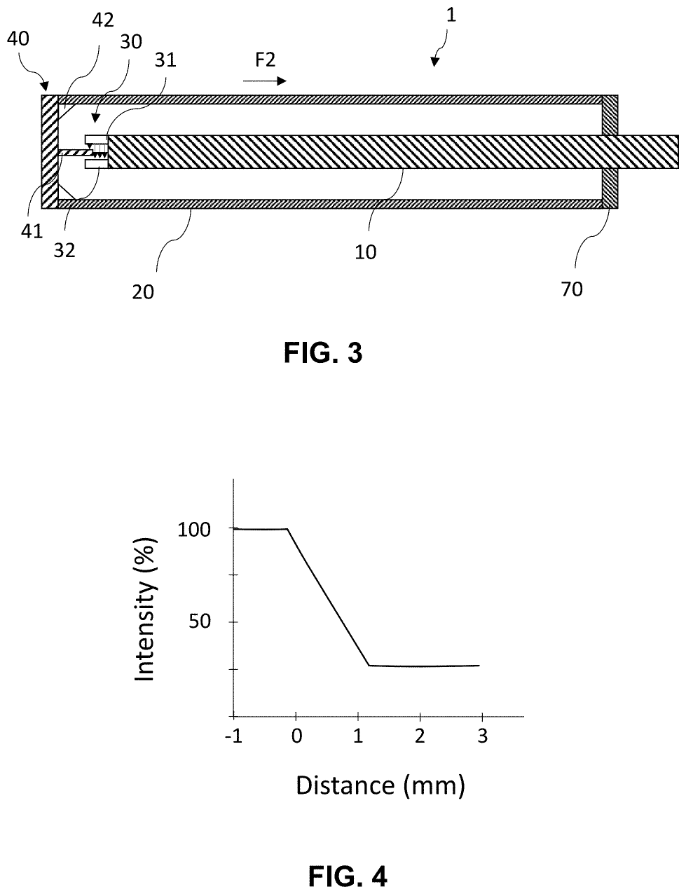

FIG. 3 is an illustration of a top view of a longitudinal section along a y-axis of a handle according to one embodiment of the invention.

FIG. 4 is a curve of light intensity received by the receiver of a photoelectric cell as a function of the displacement of a shutter element.

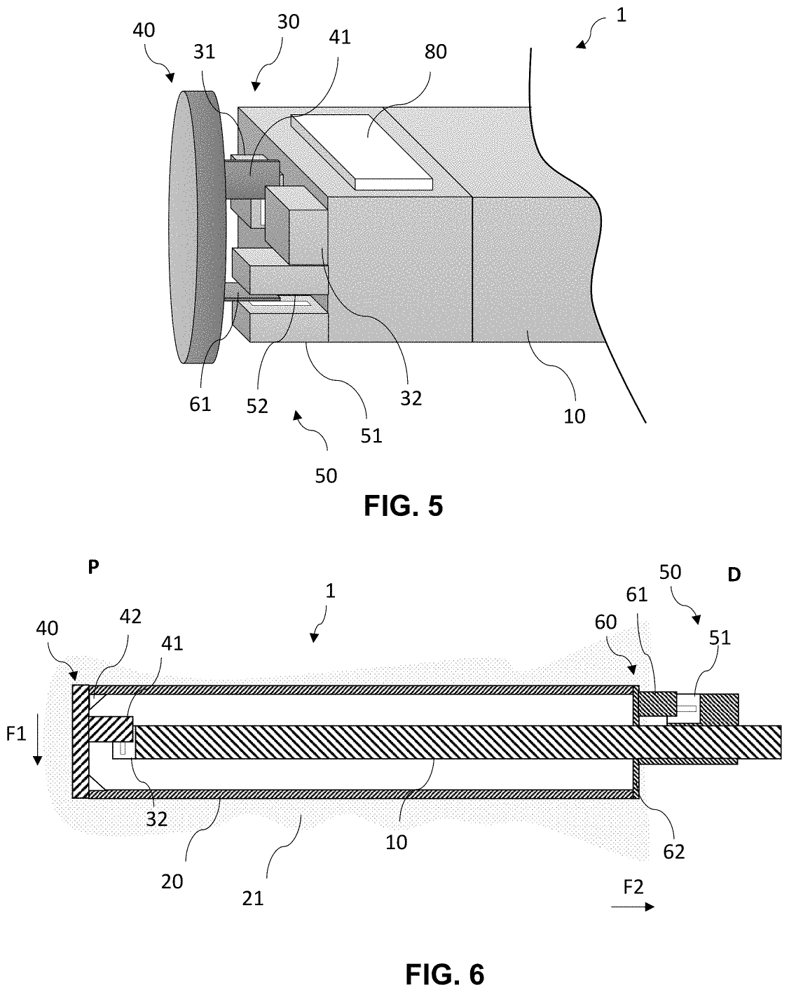

FIG. 5 is an illustration of a perspective view of a handle according to one embodiment of the invention. The outer jacket has been omitted.

FIG. 6 is an illustration of a side view of a longitudinal section along a z-axis of a handle according to one embodiment of the invention.

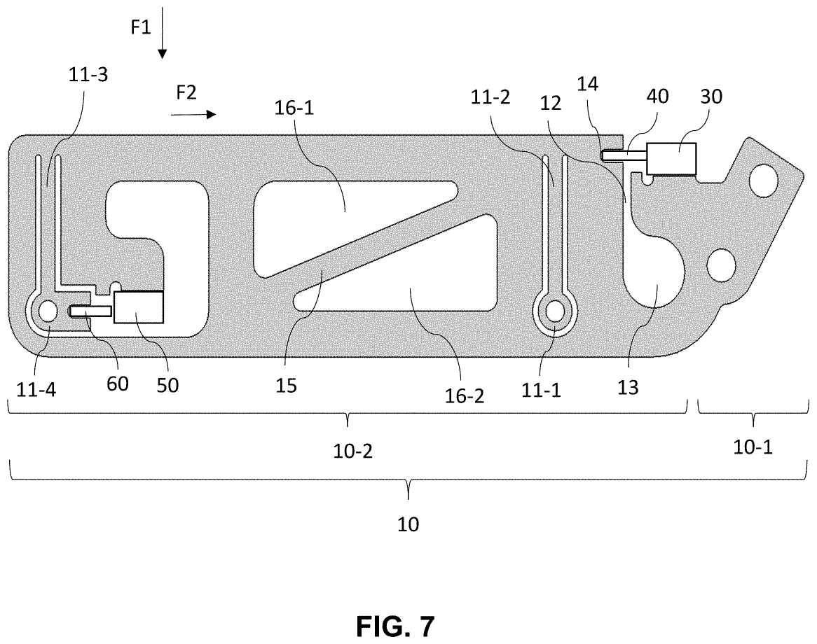

FIG. 7 is an illustration of a front view of the central part of a handle according to the invention.

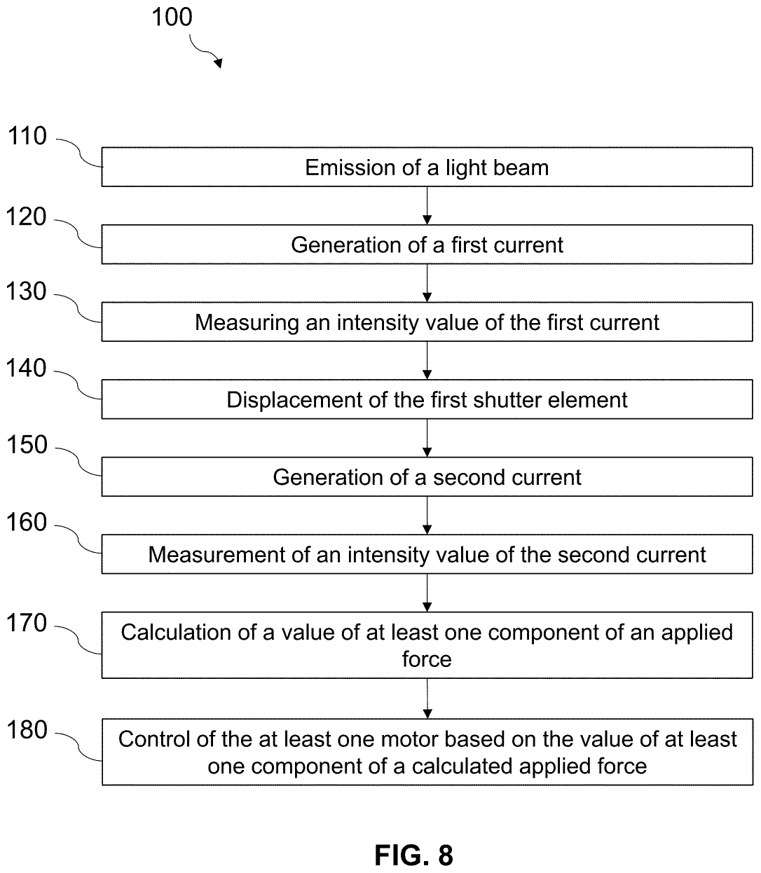

FIG. 8 is an illustrative diagram of a method according to one embodiment of the invention.

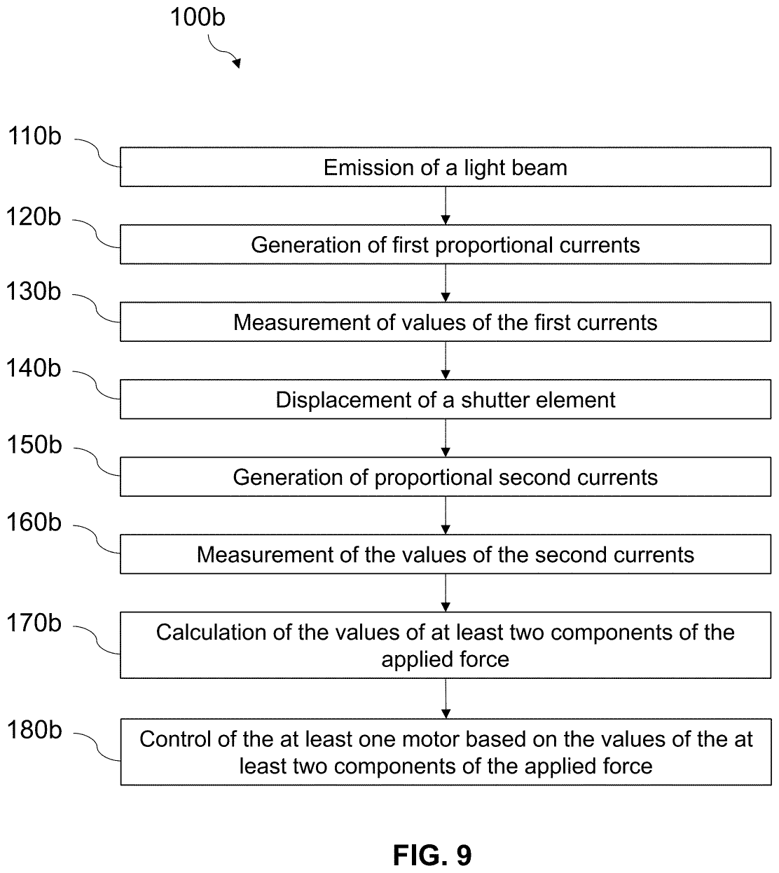

FIG. 9 is an illustrative diagram of a method according to one embodiment of the invention wherein an electronic handle has two photoelectric cells.

Aspects of the present invention shall be described with reference to flowcharts and/or block diagrams of methods or apparatus (systems) according to embodiments of the invention.

In the figures, the flowcharts and block diagrams illustrate the architecture, functionality, and operation of possible implementations of systems and methods according to various embodiments of the present invention. In this respect, each block in the flowcharts or block diagrams may show a system, device, module, or code, which comprises one or more executable instructions for implementing the one or more specified logical functions.

### DESCRIPTION OF THE INVENTION

In the following description, the expression “electronic handle” corresponds, for example, to a device for supporting the weight of a user, arranged to accommodate a hand of said user and comprising therein one or more sensors arranged to allow a measurement of a force.

The term “force”, within the meaning of the invention, corresponds to a mechanical action exerted by a user on a surface and in particular on the electronic handle. Thus, an “applied force”, within the meaning of the invention, corresponds to a user exerting pressure on the outer surface of said electronic handle.

The expression “component of a force” corresponds to a projection of a mechanical action in a direction. A “first component” thus corresponds for example to a projection of a force along an axis Z, represented by an axis orthogonal to the longitudinal axis of the electronic handle. A “second component” thus corresponds to a projection of a force along an axis X, corresponding to the longitudinal axis of the electronic handle, shown in particular in connection with FIG. 1. In the context of the present invention, at least one component of a force is considered, preferably at least two components are considered, and more preferably only two components of a force are considered.

The term “attached” corresponds to securing two distinct entities one to the other. Thus, two entities may have a removable or non-removable attachment.

The term “removable” corresponds, according to the invention, to the ability to be detached, removed, or disassembled easily without having to destroy the means of attachment either because there is no means of attachment or because the means of attachment can be easily and quickly disassembled (for example notch, screw, tongue, lug, clips). For example, by removable, is to be understood that the object is not attached by welding, or any other means not intended to allow the object to be detached.

A “non-removable” attachment according to the invention corresponds to the ability not to be detached, removed, or disassembled without having to destroy means of attachment either because there is no attachment means or because the attachment means are not easily and quickly removable. For example, by non-removable, it should be understood that the object is attached by welding or more generally by any means of irreversible securing.

The term “tubular” corresponds to a substantially elongated member forming a conduit, the lumen of which is enclosed by a wall of said conduit. Such a lumen thus refers to a hollow interior space circumscribed by the conduit wall.

When the term “substantially” is associated with a particular value, the latter is to be understood as a value varying by less than 30% with respect to the compared value, preferably by less than 20%, even more preferably by less than 10%. When substantially identical is used to compare shapes, then the vectorized shape varies by less than 30% with respect to the compared vectorized shape, preferably by less than 20%, even more preferably by less than 10%.

By “polymer” is meant either a copolymer or a homopolymer. A “copolymer” is a polymer with several different monomer units and a “homopolymer” is a polymer with identical monomer units. A polymer can, for example, be a thermoplastic or thermosetting polymer.

By “thermoplastic polymer” or “thermoplastic” is meant a polymer that can be repeatedly softened or melted by the action of heat and that adopts new shapes by the application of heat and pressure. Examples of thermoplastics are: high density polyethylene (HDPE), polyethylene terephthalate (PET), polyvinyl chloride (PVC), polystyrene (PS), or acrylonitrile butadiene styrene (ABS).

By “thermosetting polymer” is meant a plastic material that is irreversibly transformed by polymerization into an insoluble polymer network. Once the shape of the thermosetting polymer is set and cooled, it cannot be changed by heat. Thermosetting polymers are for example: unsaturated polyesters, polyimides, polyurethanes, or vinyl esters which can be epoxy or phenolic.

By “coupled” is meant, within the meaning of the invention, connected, directly or indirectly, with one or more intermediate elements. Two elements may be coupled mechanically, electrically, or linked by a communication channel.

By “process”, “calculate”, “run”, “determine”, “display”, “extract”, “compare” or more broadly an “executable operation” is meant, within the meaning of the invention, an action performed by a device or a processor unless the context indicates otherwise. In this respect, operations refer to actions and/or processes in a data processing system, such as a computer system or electronic computing device, which manipulates and transforms data represented as physical (electronic) quantities in the memories of the computer system or other devices for storing, transmitting, or displaying information. These operations may be based on applications or software.

The terms or expressions “application”, “software”, “program code”, and “executable code” mean any expression, code, or notation, of a set of instructions intended to cause a data processing to perform a particular function directly or indirectly (for example after a conversion operation into another code). Exemplary program codes may include, but are not limited to, a subprogram, a function, an executable application, a source code, an object code, a library, and/or any other sequence of instructions designed for being performed on a computer system.

Within the meaning of the invention, the term “processor” refers to at least one hardware circuit configured to execute instructions contained in the program code. The hardware circuit may be an integrated circuit. Examples of a processor include, but are not limited to, a central processing unit (CPU), a network processor, a vector processor, a digital signal processor (DSP), a field programmable gate array (FPGA), a programmable logic assembly (PLA), an application specific integrated circuit (ASIC), a programmable logic circuit, and a controller.

The expression “human-machine interface”, within the meaning of the invention, corresponds to any element allowing a human being to communicate with an electronic device.

By “motorized” is meant, within the meaning of the invention, an apparatus or a device equipped with any known suitable means (for example a motor) allowing to generate a displacement of all or part of the device with which said means is associated.

In the following description, the same references are used to designate the same elements.

Electronic handles dedicated to the analysis of the forces they experience are generally equipped with force sensors, torque sensors, pressure sensors, strain gauges, piezoelectric type technology, or simple button sensors.

In particular, these handles are integrated into walking assistance apparatus and can be used to control movement. However, such sensors are generally too expensive, fragile, and/or not very accurate.

The present invention proposes to overcome this by means of handles capable of detecting forces as low as 15 N, that is to say about 1.5 kg, and this from inexpensive and robust sensors. Furthermore, the sensitivity of the electronic handles according to the invention can be further improved depending on the materials and arrangements used to achieve a sensitivity of less than 10 N, or even less than 1 N.

In addition, the electronic handles according to the invention do not show a drift of measurement in time and do not require, contrary to other sensors such as strain gauges, recurrent recalibrations.

In order to measure these forces, a coupling between a photoelectric cell and a shutter element is used. In particular, a photoelectric cell can be a sensor consisting of an infrared transmitter and an opposite receiver. The emission area is therefore a line of infrared light. When a shutter element such as a flag penetrates between the transmitter and the receiver, the amount of light received by the receiver becomes increasingly smaller. The measurement of the current at the output of the sensor is proportional to the amount of light measured and therefore to the penetration distance of the flag. This distance can then be related to the force, applied to the handle, that caused the displacement. Thus, electronic handles according to the invention will comprise an element capable of experiencing an elastic deformation proportional to the force applied to the handle, such an element may, for example, correspond to a part of a central part of the electronic handle or to at least a part of the outer jacket of the handle.

The electronic handles according to the invention can then be used to control one or more motors, such as motors of a motorized device such as a walking assistance apparatus.

Thus, according to a first aspect, the invention relates to an electronic handle 1 arranged so as to allow the measurement of at least one component of a force being applied thereto. As illustrated in FIG. 1 and FIG. 2, a handle according to the invention includes a central part 10 and an outer jacket 20.

The central part 10 of an electronic handle 1 according to the invention may have a substantially cylindrical shape. Nevertheless, as can be seen in the illustration in FIG. 1, the central part preferably has at least one portion with a section with an edge. For example, it has a polygonal cross-section.

The central part 10 is made of a material preferably having a Young's modulus of at least 60 GPa, for example a Young's modulus of at least 175 GPa, preferably at least 200 GPa. This provides the central part 10 with a rigidity suitable for use in the electronic handle according to the invention. The central part 10 may be made of metal, a metal alloy, polymer, or a composite assembly. Preferably, the central part 10 is made of stainless steel.

The central part 10 preferably has a minimum length of 300 mm and a maximum length of 500 mm.

The outer jacket 20 of an electronic handle 1 according to the invention may have a substantially tubular, preferably tubular, shape. It can have at least one portion with a section with an edge. Nevertheless, it has a substantially ellipsoidal cross-section and more preferably a substantially circular cross-section.

The outer jacket 20 is made of a material preferably having a Young's modulus of less than 200 GPa, more preferably less than 150 GPa, and even more preferably less than 100 GPa. Such a constitution and the existence of elasticity in the outer jacket 20 allows for improved performance of the electronic handle according to the invention.

The outer jacket 20 may be made of metal, a metal alloy, polymer, or a composite assembly. Preferably, the outer jacket 20 is made of aluminum. More preferably, the outer jacket 20 is made of polymer or a composite assembly.

The outer jacket 20 preferably has a minimum length of 100 mm and a maximum length of 500 mm. In addition, the outer jacket 20 may have an outer diameter between 20 mm and 50 mm and a wall thickness between 1 mm and 3 mm.

In one embodiment, the outer jacket 20 is arranged to be capable, under the effect of a force having a vertical component, of translating at least one tenth of a millimeter with respect to an axis orthogonal to a longitudinal axis of the central part 10.

Preferably, in another embodiment, the outer jacket 20 is arranged not to move in the vertical direction with respect to the central part 10 under the effect of a power force adapted to the control of a motorized device such as a walking assistance apparatus. In particular, in this case, the central part may also be arranged so that at least a portion of the central part may, under the effect of a force having a vertical component, translate at least one tenth of a millimeter with respect to an axis orthogonal to a longitudinal axis of the central part 10. Preferably, the central part will have areas capable of deforming under the effect of a power force adapted to control a motorized device causing one part of the central part to move with respect to another part of the central part.

A displacement of at least one tenth of a millimeter may preferably correspond to a displacement of at least 0.10 millimeters to 1 millimeter.

In addition, the outer jacket 20 may be arranged to be capable, under the effect of a force having a horizontal component, of translating at least one tenth of a millimeter with respect to a longitudinal axis of the central part 10.

The central part 10 may also be arranged so that at least a portion of the central part can, under the effect of a force having a horizontal component, translate at least one tenth of a millimeter with respect to a longitudinal axis of the central part 10.

This is possible especially when there is no direct attachment between the outer jacket and the central part. In addition, the presence of joints capable of elastic deformation or an arrangement of the central part also allows such translations. As will be detailed later, attachment members passing through recesses provided in the free ends 16-1, 16-2 of embedded beams 11-2, 11-3 of the central part 10 may also be used to couple the outer jacket 20 and the central part 10.

An electronic handle 1 according to the invention includes a first photoelectric cell 30.

Photoelectric cells are electronic devices that typically include a light-emitting diode capable of emitting light pulses, usually in the near infrared range (for example 850 nm to 950 nm). This light is received or not by a photodiode or a phototransistor depending on the presence or absence of an object on the path of the light pulses. The photoelectric current created can be amplified and then analyzed.

In the context of the invention, a photoelectric cell can be selected from a barrier type photoelectric cell, a reflex type photoelectric cell, and a proximity type photoelectric cell. In addition, it is possible to use optical fibers to change the arrangement of the photoelectric cells within the scope of the invention.

In the context of the invention, a photoelectric cell is preferably a barrier type photoelectric cell for which the barrier is constituted by the shutter element 40.

Such photoelectric sensors can generally be inexpensive but robust compared to commonly used sensors.

The first photoelectric cell 30 includes a first diode 31 capable of emitting a light beam. The diode of a photoelectric cell according to the invention may correspond to an infrared diode.

In addition, the first photoelectric cell 30 includes a first receiver 32 arranged to receive the light beam emitted by the first diode. Preferably, as shown in FIG. 1, the light beam emitted by the first diode is directed directly to the first receiver 32.

The first photoelectric cell 30 is configured to generate a current of an intensity or a voltage proportional to an amount of photons received by the first receiver 32. In particular, it is the first receiver 32 that, as a light transducer, will generate a change in an electric current in response to the light beam incident on its surface. The first receiver 32 can be, for example, a photoconductor, a photodiode, or a photo transistor.

Preferably, a photoelectric cell according to the invention is configured to generate an electric current, the intensity or voltage of which will be proportional to the amount of photons received by the receiver.

In addition, the electronic handle 1 includes a first shutter element 40 that is capable of altering or arranged to alter the amount of photons received by the first receiver 32. In particular, this change in the amount of photons received is a function of the position of the first shutter element 40 with respect to the first photoelectric cell 30.

A shutter member 40, within the meaning of the invention, may be made of metal, a metal alloy, polymer, or a composite assembly. Preferably, the shutter element 40 is made of polymer, more preferably thermoplastic polymer.

The shutter element 40 may include a protrusion 41 arranged to be positioned between the diode 31 and the receiver 32 of the photoelectric cell 30. The protrusion 41 may be removably or non-removably attached to the shutter element 40. Furthermore, in the absence of a protrusion 41, it is the shutter element that accommodates between the diode 31 and the receiver 32.

Importantly, the first photoelectric cell 30 and the first shutter element 40 are at least partially movable relative to each other. Indeed, it is in particular the movement of one with respect to the other, preferably of at least a portion of one with respect to the other, that will allow a measurement of a component of a force applied to the electronic handle 1 according to the present invention. Alternatively, the first shutter element 40 and the first photoelectric cell 30 are attached directly or indirectly to portions of the central part and these portions may be movable relative to each other.

Thus, according to an embodiment illustrated in FIG. 1 or 2, of the first photoelectric cell 30 and the first shutter element 40, one is attached to the outer jacket 20 and the other is attached to the central part 10. In particular, if one is attached to the outer jacket, it will not be attached to the central part and vice versa. FIG. 2 shows, for example, means for attaching 42 the shutter element 40 to the outer jacket 20. The attachment is preferably a removable attachment.

In particular, the positioning of the first photoelectric cell 30 and the first shutter element 40 on the central part or the attachment of the shutter element 40 to the outer jacket 20 will be done in such a way that a force F1 applied to the electronic handle 1, if sufficient to move the outer jacket 20 at least partially, then it will cause a change in the amount of photons received by the first receiver 32. Furthermore, since the position of the first shutter element 40 allows the amount of photons received by the first receiver 32 to be influenced, then the change in the amount of photons received by the first receiver 32 will be correlated, preferably proportionally, to a first component of the force that was applied to the electronic handle 1.

As illustrated in FIG. 3, the attachment will be made so that a force F2 applied to the electronic handle 1, if sufficient to move the outer jacket 20 at least partially, then it will cause a change in the amount of photons received by the first receiver 32. Furthermore, since the position of the first shutter element 40 allows the amount of photons received by the first receiver 32 to be influenced, then the change in the amount of photons received by the first receiver 32 will be correlated, preferably proportionally, to a second component of the force that was applied to the electronic handle 1. As illustrated, the handle may include an elastically deformable member 70, such as a polymer, so as to allow translation of the outer jacket 20 with respect to the central part 10.

The handle may also include a central part 10 arranged so that a portion of the central part 10 moves under the action of a force F1 applied to the electronic handle 1, resulting in a change in the amount of photons received by the first receiver 32, and a portion of the central part 10 moves under the action of a force F2 applied to the electronic handle 1, resulting in a change in the amount of photons received by the second receiver 52.

Thus, the electronic handle according to the present invention may include a sensor of a vertical or horizontal force component through or without a measurement of a displacement of the outer jacket with respect to the central part 10, the displacement being caused by a force having a vertical component and/or a horizontal component. Thus, the displacement may involve only a portion of the outer jacket and may be understood as a deformation of the outer jacket. Preferably, the outer jacket 20 deforms negligibly and experiences only a displacement along the horizontal as a function of the force applied thereto.

In a particular embodiment, the electronic handle 1 has a fixed horizontal shaft, for example made of steel, which can be connected to a walking assistance apparatus (for example a walker) and which serves as a reference. It also includes an outer jacket 20 that can take the form of an outer tube that can translate, under the effect of the horizontal component of the force, by one tenth of a millimeter with respect to the central axis and that, under the effect of the vertical component of the force, deforms in the sagittal plane like an embedded beam. The measurement of this force can be done by a processor for example placed in the electronic handle 1 or in the walking assistance apparatus.

As illustrated in FIG. 4, a photoelectric cell as used in the present invention is preferably configured to be able to generate an electric current, the intensity or voltage of which is correlated, preferably proportional, to the position of a shutter element. Thus, the change in the amount of photons received by the receiver will be proportional to a component of the force that was applied to the electronic handle 1.

As shown in FIG. 4, the relationship between distance and intensity is preferably linear over at least 1 mm.

As illustrated in FIG. 5, an electronic handle 1 according to the present invention may also include at least a second photoelectric cell 50.

This second photoelectric cell 50 may share the same characteristics as the first photoelectric cell 30 and in particular its preferred or advantageous characteristics.

Like the first photoelectric cell, the second photoelectric cell 50 includes a second diode 51 capable of emitting a light beam. It also includes a second receiver 52 arranged to receive said light beam. In addition, the shutter element 40 may include a second protrusion 61, an example of which will be discussed in more detail in connection with FIG. 6.

In addition, the second photoelectric cell 50 is arranged so that a force applied to the electronic handle 1 is capable of changing a change in the amount of photons received by the second receiver 52. Generally, the force applied to the electronic handle 1 will be capable of causing a change in the amount of photons received by the second receiver 50 if it is capable of moving the outer jacket 20 at least partially.

Advantageously, the change in the amount of photons received is proportional to a second component of the force that was applied to the electronic handle 1.

Thus, the presence of a second photoelectric cell 50 allows for better characterization of the force applied to the handle.

In addition to the ability to measure a second force component, this allows for the calibration of the electronic handle without manual intervention on the handle and its electronics. In fact, a ‘zero’ is obtained when no force is applied to the system and the measured force can correspond to a percentage of the displacement of the shutter element, for example, with respect to a maximum displacement.

The photoelectric cells 30, 50 can be attached directly to the central part 10. As shown in FIG. 5, the photoelectric cells 30, 50 can be attached indirectly to the central part 10. In particular, an intermediate element 11 can be used. The intermediate element 11 is attached to the central part while the photoelectric cells 30, 50 are attached to the intermediate element 11.

This may allow a handle according to the invention to be manufactured more quickly and facilitates its possible maintenance.

In addition, an electronic handle 1 according to the present invention may also include an electronic board 80. Such an electronic board 80 could be configured to measure the output voltage of the photoelectric cell and then transform it into a digital data.

Advantageously, the electronic board 80 is configured to sample the current measurement on 10 bits, which corresponds to 1024 values. Such a sampling allows a resolution of the measurement of the order of a thousandth of a millimeter.

In particular, the electronic board 80 is configured to measure an output voltage or intensity and sample it over at least 4 bits, preferably at least 10 bits.

Considering the correlation between the output voltage or intensity and the displacement in millimeters of a shutter element with respect to a photoelectric cell, on the one hand, and the correlation between the displacement in millimeters of the outer jacket 20 with respect to the central part 10 and the applied force, on the other hand, the electronic board 80, or an electronic board arranged outside the handle, may be configured to transform the information generated by a photoelectric cell into information on the intensity of the force applied on the electronic handle.

As shown in FIG. 6, an electronic handle 1 according to the present invention may also include a second shutter element 60.

The horizontal and vertical displacement measurements can then be decoupled. A first sensor is used for the deformation of the handle due to a vertical component F1 and a second sensor is used for the horizontal movement of the handle due to a horizontal component F2. Moreover, the presence of the two sensors allows an automatic calibration (that is to say without manipulation of the sensor).

This second shutter element 60 may share the same characteristics as the first shutter element 40 and in particular its preferred or advantageous characteristics. For example, the second shutter element 60 may include a protrusion 61 arranged to intersect the light beam generated by the second diode 51.

Thus, the second shutter element 60 is capable of changing the amount of photons received by the second receiver 52. This change is in particular a function of its position with respect to the second photoelectric cell 50.

In addition, the second shutter element 60 may include a membrane 62, said membrane 62 being arranged to transmit a displacement of the outer jacket 20, for example subjected to a horizontal force component, to a protrusion 61. In particular, the connection to the outer jacket 20 may be a slat that deforms according to the horizontal force exerted by the user. On this slat is rigidly attached a protrusion such as a flag which is used for measurement. Since the deformed portion is in its elastic zone, the deformation is proportional to the force. Alternatively, the second shutter element 60 and the second photoelectric cell 50 are attached directly or indirectly to portions of the central part and these portions may be movable relative to each other. Preferably, the central part is arranged so that the second shutter member 60 and the second photoelectric cell 50 are attached directly or indirectly to portions of the central part that can move independently and portions of the central part to which the first shutter member 40 and the second photoelectric cell 50 are attached directly or indirectly.

Advantageously, the second force component will be perpendicular to the first force component.

Thus, the electronic handle 1 according to the present invention may include a sensor for deformation of the outer jacket 20, and more broadly of the handle 1, due to a horizontal component.

To this end, the second photoelectric cell 50 is preferably positioned substantially perpendicular, preferably perpendicular to the first photoelectric cell 30. More particularly, the axis of a light beam formed by the first photoelectric cell 30 is perpendicular to the light axis formed by the second photoelectric cell 50.

In one embodiment, when the electronic handle 1 includes a second photoelectric cell 50 and a second shutter element 60, one is attached to the outer jacket 20 and the other, not attached to the outer jacket 20, is attached to the central part 10.

Nevertheless, when the electronic handle 1 includes a second photoelectric cell 50 and a second shutter element 60, advantageously one is attached to the central part 10 and the other, not attached to the central part 10, is attached to a part coupled to the electronic handle. This part can for example correspond to a junction element between the electronic handle and a frame element.

Alternatively, as mentioned above and as will be detailed later, the shutter elements and photoelectric cells can all be attached to the central part. This attachment can be direct or indirect.

Typically, at least one shutter element 40, 60 is attached directly or indirectly to the outer jacket 20. This attachment can be a removable or non-removable attachment. Further, in one embodiment, if a shutter element is attached to the outer jacket 20, then it will not be attached to the central part 10.

Similarly, at least one photoelectric cell 30, 50 is attached directly or indirectly to the outer jacket 20. This attachment can be a removable or non-removable attachment. In addition, if a photoelectric cell is attached to the outer jacket, then it will not be attached to the central part 10.

Advantageously, the one or more photoelectric cells 30, 50 are attached to the ends of the outer jacket 20. Preferably, they are attached to the opposite ends of the outer jacket 20. In particular, as illustrated in FIG. 6, the photoelectric cell 30 arranged for a measurement of a vertical force component F1 is preferably positioned in a proximal quartile P of the electronic handle 1 while the photoelectric cell 50 arranged for a measurement of a horizontal force component F2 is preferably positioned in a distal quartile D of the electronic handle 1. This allows an improvement in measurement accuracy and sensitivity.

Advantageously, to facilitate the horizontal displacement of the outer jacket, linear ball bearings are used, and a linear ball guide type part is used to make the connection between the central axis and the outer tube.

The outer jacket may further be covered with an ergonomic shape 21 to facilitate the grip of the electronic handle 1. The ergonomic shape 21 can be made of polymers or any other material.

Thus, the force applied by a hand on the handle is modeled by a force, F, in the sagittal plane, having a vertical component, F1, and a horizontal component, F2, in the user's walking direction.

Such an electronic handle allows the user to bypass the compressions made by the user when using the handle and focus on actions involving a force associated with a given direction.

Such an electronic handle is particularly suitable for use in a motorized device. Indeed, an electronic handle 1 according to the invention can be configured to control at least one motor of a motorized device.

A motorized device may be, for example, a robotic arm, a lifting device, or a walking assistance apparatus, or an ambulatory device.

In particular, the electronic handle 1 can be configured to control one or more motors of the motorized device alone or in cooperation with one or more processors that can be positioned outside the electronic handle 1. The motor controls can be calculated at the handle or externally according to the values of the two force components calculated from the measurements made by the photoelectric cells positioned in the handle. In addition, the motor controls can take into account the values of the force components calculated from the measurements made by the photoelectric cells positioned in a second handle and can also integrate values from other sensors such as a proximity sensor.

Furthermore, as has been widely described, such an electronic handle 1 is advantageously fitted with sensors measuring forces along the length of the handle and perpendicular to the length of the handle in a decorrelated manner.

Tables 1 and 2 below show a measurement of the displacement of the shutter elements 40, 60 as a function of the force applied to the electronic handle 1.

TABLE 1
Measurement of the displacement of the shutter elements
40, 60 as a function of the force applied to the electronic
handle 1 consisting of a vertical component.

| Force | Displacement of the first | Voltage generated by the |
|---|---|---|
| (N) | shutter element (mm) | first photoelectric cell (mV) |
| 30 | 0.05 | 594.5 |
| 60 | 0.1 | 642.8 |
| 90 | 0.13 | 691.5 |
| 120 | 0.17 | 738.4 |
| 150 | 0.24 | 786.3 |
| 180 | 0.3 | 834.3 |

Table 1 clearly shows a displacement of the first shutter element and an output voltage of the photoelectric cell having a substantially linear function with respect to the applied force along a vertical component. On the contrary, the second shutter element is not significantly impacted by a vertical component. This displacement results in a linear change in the voltage generated by the first photoelectric cell (R²>0.999 with a first-degree equation) while the voltage generated by the second photoelectric cell has a standard deviation of less than 5%.

TABLE 2
Measurement of the displacement of the shutter elements
40, 60 as a function of the force applied to the electronic
handle 1 consisting of a horizontal component.

| | | Voltage generated | Voltage generated |
|---|---|---|---|
| | Displacement of | by the first | by the second |
| Force | the second shutter | photoelectric | photoelectric |
| (N) | element (mm) | cell (mV) | cell (mV) |
| 5 | 0.01 | 557.4 | 760.1 |
| 10 | 0.03 | 557.8 | 752.2 |
| 15 | 0.04 | 557.0 | 743.6 |
| 20 | 0.05 | 556.3 | 735.0 |
| 30 | 0.08 | 559.5 | 632.8 |

Similarly, Table 2 shows a displacement of the second shutter element with a substantially linear function with respect to the applied force along a horizontal component. On the contrary, the displacement of the second shutter element is not significantly impacted by a vertical component. On the contrary, the first shutter element is not significantly impacted by a horizontal component. This displacement results in a linear change in the voltage generated by the second photoelectric cell (R²>0.999 with a first degree equation) while the voltage generated by the second photoelectric cell has a standard deviation of less than 1%.

The presence of two photoelectric cells and their arrangement so that they measure perpendicular direction components allows calibration without manual intervention on the electronic handle and its electronics. Thus constituted, the system, inexpensive, has two advantages compared to other systems: i) it allows to acquire independent measurements and ii) the measurements are self-calibrated, since a ‘zero’ can be obtained when no force is applied on the system and the measured applied force can then advantageously correspond to a percentage of the displacement of the shutter element compared to a maximum displacement.

As shown in connection with FIG. 7, an electronic handle 1 according to the present invention may also be arranged to allow measurement of at least two components of a force applied thereto.

To this end, each of the electronic handles 1 advantageously includes a central part 10 comprising a first photoelectric cell 30, a first shutter element 40, a second photoelectric cell 50, and a second shutter element 60.

As already partly detailed in connection with FIGS. 1 to 6, the shutter elements 40, 60 are arranged so as to be capable, depending on their position with respect to their respective photoelectric cell 30, 50, of changing the amount of photons received by the receiver 32, 52.

In this embodiment, the first photoelectric cell 30 and the first shutter element 40 are arranged so that a force applied to the electronic handle 1 having a first component capable of at least partially moving the central part 10, is capable of causing a change in the amount of photons received by the first receiver, the change being proportional to a first component of the force that has been applied to the electronic handle 1.

In addition, the second photoelectric cell 50 includes a second diode 51 capable of emitting a light beam and a second receiver 52 arranged to receive said light beam. The second photoelectric cell 50 is configured to generate a current proportional (of proportional voltage or intensity) to an amount of photons received by the second receiver 52.

The second shutter element 60 is capable, depending on its position with respect to the second photoelectric cell 50, of changing the amount of photons received by the second receiver 52. Furthermore, the second photoelectric cell 50 and the second shutter element 60 are arranged so that a force applied to the electronic handle 1 including a second component capable of at least partially moving the central part 10 is capable of causing a change of the amount of photons received by the second receiver 52, said change being proportional to a second component of the force that has been applied to the electronic handle 1.

It is thus possible to determine at least two components of a force applied to each of the two handles and directly causing a displacement (at least a partial deformation) of the central part 10. The two electronic handles 1 can thus be configured to control a motor fitted to the walking assistance apparatus according to the values of the two calculated force components. As a non-limiting example, the motor control can generate a displacement of a motorized device such as a walking assistance apparatus. Such a control can be subject to the determination of the values of the two components of an applied force and calculated for the two handles, respectively.

In order to allow the independence of the measurements between the two components of a force F2 (for example horizontal) applied on each of the electronic handles 1, the latter (and in particular the position of the photoelectric cells and of the shutter elements) can be arranged in such a way that the first component of the force F2 applied to the electronic handle 1 is not capable of causing a change of the amount of photons received at the second photoelectric cell 50, but only at the first photoelectric cell 30.

Similarly, each of the electronic handles 1 can also be configured so that the force F1 applied to the electronic handle 1, including a second component perpendicular to the first component, is not capable of causing a change in the amount of photons received at the first photoelectric cell 30, but only at the second photoelectric cell 50.

In addition, the central part 10 may include an attachment region 10-1 to a motorized device such as a walking assistance apparatus according to the present invention, as well as a support region 10-2.

The attachment region 10-1 may consist of a longitudinal extension of the support region 10-2 and may include a plurality of recesses, such as a plurality of screw threads, adapted to receive attachment elements, such as, by way of non-limiting examples, a plurality of screws, for connecting the electronic handle 10 to the walking assistance apparatus.

The support region 10-2 is adapted to allow a user to lean thereon when the user interacts with the motorized device or walking assistance apparatus. Thus, in this embodiment, it is the central part 10 that directly experiences a deformation when a force is applied by the user.

In order to provide independent measurements in at least two dimensions, that is to say in order to measure at least two components of a force applied to the electronic handle 1 independently, the support region 10-2 of the central part 10 can advantageously comprise at least one embedded beam and a deformation bridge.

The embedded beam advantageously comprises an embedded end 11-2, 11-3 and a free end 11-1, 11-4. The embedded end 11-2, 11-3 is connected to the central part while the free end 11-1, 11-4 has a degree of freedom allowing a displacement of said free end when applying a force on the electronic handle 1. Advantageously, the embedded beams are arranged in such a way as to have a degree of freedom when a force F2 is applied along a first component, but not to have a degree of freedom when a force F2 is applied along a second component perpendicular to the first component.

As an illustrative example, the free end 11-1, 11-4 may have a degree of freedom along a specific axis such as the axis of one of the components of the applied force. This allows for a displacement of the free end 11-1, 11-4 only if the applied force has a given non-zero component. For example, the free end 11-1, 11-4 may have a degree of freedom allowing a displacement of said free end along the axis of the second component of the applied force, where said second component of the applied force may correspond to a horizontal component F2.

Preferably, the support region 10-2 of the central part 10 can advantageously comprise at least two embedded beams, preferably arranged at the ends, along a longitudinal axis, of the central part 10.

In addition, a deformation bridge of the central part 10 may comprise a through opening 12 opening onto a recess 13. The through opening 12 is arranged to be elastically deformable when a force is applied to the electronic handle 1. Specifically, the volume of the through opening 12 may increase or decrease as force is applied to the electronic handle 1.

By way of an illustrative example, the through opening 12 may be arranged so that its volume varies only upon the application of a force having a particular component. This allows an increase or decrease in the volume of the through opening 12, by a displacement of the central part 10 and more particularly of the support region 10-2, only if the applied force has a given non-zero component (for example a vertical component).

Thus, the increase or decrease in the volume of the through opening 12 may be generated along a specific axis of an applied force, such as the axis of one of the components of the applied force. For example, the through opening 12 may be arranged to allow a displacement of the support region 10-2, and thus an increase or decrease in the volume of the through opening 12 along the axis of the first component of the applied force, where said first component of the applied force may correspond to a vertical component F1.

Advantageously, the second photoelectric cell 50 can be attached to the central part 10, within a suitable cavity. The second shutter element 60 will be in this case attached directly to a free end 11-1, 11-4 of an embedded beam. Indeed, the application of a force on the support region 10-2, if sufficient, will induce an elastic deformation of the central part 10. Such a deformation can be measured if the second component of the applied force is non-zero, resulting in a change of the amount of photons received by the second receiver 52. Indeed, the elastic deformation will cause a displacement of the second shutter element 60 attached to the free end 11-1, 11-4 along the axis of the second component of the applied force, thus blocking all or part of the light beam received by the receiver 52 and generated by the diode 51.

In order to measure the first component of the force applied to the support region 10-2, the first photoelectric cell 30 and the first shutter element 40 may be positioned on either side of the through opening 12 of the deformation bridge, respectively. Indeed, the application of a force on the support region 10-2, if sufficient, will induce an elastic deformation of the central part 10. Such a deformation can be measured if the first component of the applied force is not zero, resulting in a change of the amount of photons received by the first receiver 32. Indeed, the elastic deformation will cause a displacement of the first shutter element 40 attached to the central part 10, more particularly in an adapted housing 14, along the axis of the first component of the applied force, thus blocking all or part of the light beam received by the receiver 32 and generated by the diode 31.

In order to reduce the weight of the central part 10 and to reduce the occurrence of pre-stresses at the deformation bridge, the central part 10 may include at least two central openings 16-1, 16-2 through which a portion 15 of the central part extends, said central openings being positioned between the at least one embedded beam 11-2, 11-3 and the deformation bridge. When the central part 10 includes two embedded beams 11-2, 11-3, the two central openings 16-1, 16-2 are positioned between said embedded beams.

Such pre-stresses can generate elastic deformation of the deformation bridge and potentially a change in the amount of photons received by the first receiver 32.

As previously described, each of the electronic handles 1 may include an outer jacket 20, said outer jacket 20 being coupled and/or attached to the central part 10. Preferably, the outer jacket 20 is not attached to the central part 10, but is only coupled, for example, by one or more force transmitting elements.

To this end, one or more force transmitting elements of the outer jacket 20 are arranged so as to pass through a housing provided in the free end 11-1, 11-4 of the embedded beam 11-2, 11-3. A force transmitting element can for example correspond to a screw, a tube, a cylinder, such as a pin connecting the two parts of the outer jacket 20 and passing through the central part 10 in housings provided in the free end 11-1, 11-4 of the embedded beam 11-2, 11-3.

Preferably, in the absence of a force applied to the electronic handle, the force transmitting element is not in direct or indirect contact with the central part. Preferably, the housing provided in the free end 11-1, 11-4 of the embedded beam 11-2, 11-3 has a member, such as a pin, with a clearance fit. The outer jacket 20 preferably transmits external forces to the central part 10 through the pins passing through the central part in its parts 11-1 and 11-4, having a clearance fit. In particular, the pins may correspond to metal cylinders passing through the central part 10 at the free end 11-1 and 11-4 and being accommodated in the outer part 20. These pins are advantageously mounted with a clearance so that they can rotate freely, thus only transmitting forces from the outer part to the central part.

Such a force transmitting element avoids torsional forces that can interfere with measurements when a force is applied by a user. Thus, such an arrangement allows to improve the accuracy of the measurement and in particular its linearity.

The handle may also include an attachment element such as a screw passing through the central part 10 into the central openings 16-1 and 16-2.

Thus, according to another preferred aspect, the present invention relates to a motorized device such as a walking assistance apparatus, equipped with at least one, preferably at least two, electronic handles 1 according to the invention. Preferably, the walking assistance apparatus can be selected from: a cane, a crutch, a walker, a motorized walker, and a motorized chair.

Furthermore, a walking assistance apparatus according to the invention will be equipped with at least one motor and said motor will be configured to be at least partially controllable based on a value of a force component calculated by a handle according to the invention.

Thus, according to another preferred aspect, the invention relates to a method 100 for controlling a walking assistance apparatus.

In particular, a method includes calculating a value of at least one component of a force applied to an electronic handle 1 according to the invention.

As illustrated in FIG. 8, the method may begin with the emission 110 of a light beam from the first diode 31.

If this light beam is received by the first receiver 32, that is to say if the shutter element 40 has not completely blocked the beam, a first current will be generated 120 proportional to the amount of photons received by the first receiver 32.

The method may then include a measurement 130 of an intensity or voltage value of the first current. This measurement can for example be made by an electronic board 80 and then translated into digital information.

When the first shutter element 40 moves 140 due to a force applied to said electronic handle 1, then it may reduce the amount of photons received by the first receiver 32.

Thus, a second current 150 will be generated proportional (for example of proportional intensity or voltage) to an amount of photons received by the first receiver 32, and then a measurement 160 of a value of intensity or voltage of the second current will be made for example by an electronic board.

The method may then include a step of calculating 170 a value of at least one component of an applied force from the intensity or voltage values of the first current and the second current. This calculation can for example be done by a processor, preferably coupled to a memory. In particular, the step 170 may correspond to calculating a difference value between the intensity or voltage values of the first current and the second current, said difference between the intensity or voltage values of the first current and the second current being proportional to a first component of the force that was applied to the electronic handle 1.

Thus, the method makes it possible to determine a value of at least one component of a force. This value can then be used to control 180 at least one of the motors of the walking assistance apparatus. This control can, for example, be realized by a control module comprising means arranged and configured to execute this function.

The control can, for example, involve the transmission of a control command to a servomotor or a change in the current value transmitted to a motor.

The implementation of the invention thus allows to control a robotic device from simple, robust, and inexpensive components.

Because of these advantages, it is possible, for example, to produce walking assistance apparatus that are able to measure a users interaction with the apparatus and to derive travel instructions therefrom. This is possible in particular thanks to the electronic handles according to the invention playing the role of a human-machine interface between the user and the walking assistance apparatus.

1. A walking assistance apparatus comprising at least one motor, at least one electronic handle, the at least one electronic handle being arranged so as to allow the measurement of at least two components of a force applied thereto, said at least one electronic handle comprising:
a first photoelectric cell, said first photoelectric cell comprising a first diode capable of emitting a first light beam and a first receiver arranged to receive said first light beam, said first photoelectric cell being configured to generate a current proportional to an amount of photons received by the first receiver, and
a first shutter element capable, depending on its position with respect to the first photoelectric cell, of changing the amount of photons received by the first receiver,
the first photoelectric cell and the first shutter element being arranged so that the force applied to the at least one electronic handle is capable of causing a change in the amount of photons received by the first receiver, said change being proportional to a first component of the force that has been applied to the at least one electronic handle,
a second photoelectric cell comprising a second diode capable of emitting a second light beam and a second receiver arranged to receive said second light beam, said second photoelectric cell being configured to generate a current proportional to an amount of photons received by the second receiver,
a second shutter element capable, depending on its position with respect to the second photoelectric cell, of changing the amount of photons received by the second receiver,
the second photoelectric cell and the second shutter element being arranged so that the force applied to the at least one electronic handle is capable of causing a change of the amount of photons received by the second receiver, said change being proportional to a second component of the force that has been applied to the at least one electronic handle,
a central part on which are fixed the first photoelectric cell, the first shutter element, the second photoelectric cell and the second shutter element,
said at least one electronic handle being configured to control said motor depending on values of the two force components, and
said at least one electronic handle being arranged so that a force, adapted to the control of the walking assistance apparatus, applied to the at least one electronic handle is capable of at least partially deform the central part.

2. The walking assistance apparatus according to claim 1, wherein it comprises two electronic handles.

3. The walking assistance apparatus according to claim 1, wherein the two components, on which the changes in the amounts of photons received by the receivers depend, are components with respectively perpendicular directions.

4. The walking assistance apparatus according to claim 1, wherein the at least one electronic handle is configured so that the first component and the second component of the force applied to the at least one electronic handle are not capable of causing a significant change in the amount of photons received by the second receiver and by the first receiver, respectively.

5. (canceled)

6. (canceled)

7. The walking assistance apparatus according to claim 1, wherein the central part comprises at least one embedded beam comprising an embedded end and a free end, said free end having a degree of freedom along a direction of the second component of the applied force.

8. The walking assistance apparatus according to claim 7, wherein the free end has no degree of freedom along a direction of the first component of the applied force.

9. The walking assistance apparatus according to claim 7, wherein the second photoelectric cell is attached to the central part within a suitable cavity and the second shutter element is attached to the free end of the embedded beam.

10. The walking assistance apparatus according to claim 7, wherein the at least one electronic handle comprises an outer jacket coupled to the central part via at least one force transmitting element arranged to pass through a housing provided in the free end of the at least one embedded beam.

11. The walking assistance apparatus according to claim 10, wherein the force transmitting element is arranged not to be in direct or indirect contact with the central part in the absence of a force applied to the at least one electronic handle, wherein preferably the force transmitting element has a clearance fit at the housing provided in the free end.

12. The walking assistance apparatus according to claim 1, wherein the central part comprises a deformation bridge comprising a through opening that opens onto a recess, said through opening being arranged to experience elastic deformation as a function of the first component of the applied force.

13. The walking assistance apparatus of claim 12, wherein the first photoelectric cell and the first shutter element are respectively positioned on either side of the through opening of the deformation bridge.

14. The walking assistance apparatus according to claim 1, wherein the central part is made of a material having a Young's modulus greater than or equal to 60 GPa.

15. The walking assistance apparatus according to claim 1, said walking assistance apparatus is being selected from: a motorized cane, a motorized crutch, a motorized walker, a walker with a lifting function, and a motorized chair.

16. A method for controlling the walking assistance apparatus according to claim 1, said method comprising a measurement of the values of at least two components of a force applied to an electronic handle, said electronic handle comprising a first photoelectric cell having a first diode and a first receiver, and a first shutter element and a second photoelectric cell comprising a second diode and a second receiver, and a second shutter element, said measurement of a value of at least two components of a force applied to said electronic handle comprising the following steps:
Emitting a light beam by the first diode and second diode,
Generating first currents proportional respectively to amounts of photons received by the first receiver and second receiver,
Measuring values of the first currents,
Moving the first shutter member and/or the second shutter member under the effect of a force applied to said electronic handle,
Generating second currents proportional to an amount of photons received by the first receiver and second receiver, respectively,
Measuring values of the second currents (160b), and
Calculating values of at least two components (170b) of the force applied to the electronic handle from the values of the first currents and the second currents;
said method (110b) further comprising a step of controlling the at least one motor depending on the calculated values of the at least two components of the force applied to the electronic handle.
